(19) United States
(12) Patent Application Publication
(10) Pub. No.: US 2021/0116771 A1
(43) Pub. Date: Apr. 22, 2021

(54) PRIVACY APPLICATION DEVICE, METHOD FOR OPERATION THEREOF, AND SYSTEM INCLUDING A PRIVACY APPLICATION DEVICE

(71) Applicant: Applied Materials, Inc., Santa Clara, CA (US)

(72) Inventor: Rainer DEMUTH, Bruchköbel (DE)

(21) Appl. No.: 17/047,576

(22) PCT Filed: Apr. 17, 2018
(86) PCT No.: PCT/EP2018/059770

§ 371 Date: Oct. 14, 2020

(51) Int. Cl. G02F 1/167; G03B 11/04; G02F 1/16757; G02F 1/1681

(52) U.S. Cl. CPC G02F 1/167; G03B 11/043; G02F 2001/1678; G02F 1/1681; G02F 1/16757

(57) ABSTRACT

The present disclosure provides a privacy application device and a method for operating the same. The privacy application device comprises a electro- or magnetophoretic medium and a controller, wherein the privacy application device is switchable between a transparent state and a non-transparent state. The method for operating the privacy application device comprises applying an alternating voltage to the electro- or magnetophoretic medium, controlling at least one of the amplitude and duration of the voltage to switch the privacy application device between a transparent state and a non-transparent state, and removing the voltage.

### TECHNICAL FIELD

Embodiments of the present disclosure relate to a privacy application device, a method for operation of a privacy application device, a system including a privacy application device, and its use in a camera unit. Embodiments of the present disclosure particularly relate to methods and apparatus used in privacy applications, more particularly in privacy shutters for cameras.

### BACKGROUND

Privacy and security are becoming increasingly relevant topics in the design of electronic devices. In-built cameras are ubiquitous in many electronic devices, including mobile phones, tablets and laptop computers, introducing privacy and security issues relating to unauthorized access to cameras.

Various devices and methods exist for protecting users against unauthorized access to cameras in electronic devices.

One such device is a mechanical shutter that includes an opaque shutter component which slides in front of a camera unit, such that the camera is covered when not in use. A mechanical shutter has the advantage of low cost, isolation from external control, stability without applied power, and 100% transmissivity when open. However, a mechanical shutter has significant thickness and width, which may be unsuitable for integration into increasingly compact electronic devices with narrow screen bezels and thin housings. Further, mechanical shutters include small moving parts which are prone to breakage.

Another such device is a shutter including polymer dispersed liquid crystals (PDLC). A PDLC shutter includes a layer of PDLC material which is switched between a light-transmission state and a light-scattering state through the application of a voltage. A PDLC shutter is solid-state and electrically controllable; however in order for a PDLC material to remain in a light-scattering state, a continuous supply of voltage is maintained. Further, PDLC material when in a light-transmission state has a transmissivity of 85% or less, which reduces camera performance. In addition, the haze level of PDLC material is normally as high as 5% or more when in a transparent state, which causes a blurring effect during camera recording.

Therefore, there exists a need for apparatus and methods for improving privacy and security from unauthorized access to cameras in electronic devices. The present disclosure particularly aims to improve privacy and security such that the apparatus or method may be stable without applied voltage.

### SUMMARY

In light of the above, a privacy application device, a method for operation of a privacy application device, a system including a privacy application device, and a use of the privacy application device in a camera unit are provided. Further aspects, benefits, and features of the present disclosure are apparent from the claims, the description, and the accompanying drawings.

According to an aspect of the present disclosure a privacy application device is provided. A privacy application device comprises a shutter device including an electro- or magnetophoretic medium, an aperture, and at least two electrodes, and a controller unit. Further, the electro- or magnetophoretic medium includes mobile charged particles and a transport medium, wherein the privacy application device is switchable between a transparent state and a non-transparent state.

According to a further aspect of the present disclosure, a method for operating the privacy applications device is provided. The method includes setting up the polarity of the at least two electrodes individually by applying or removing a voltage and controlling at least one of the amplitude and duration of the voltage to switch the privacy application device between a transparent state and a non-transparent state.

According to a further aspect of the present disclosure, a use of a privacy application device is provided. The use includes using a privacy application device for a privacy shutter optically positioned in front of at least one camera unit.

According to a further aspect of the present disclosure, a system is provided. The system includes an electronic device comprising at least one camera unit and a privacy application device, wherein the privacy application device is positioned in front of at least one camera unit.

Embodiments are also directed at apparatuses for carrying out the disclosed method and include apparatus parts for performing each described method aspect. These method aspects may be performed by way of hardware components, a computer programmed by appropriate software, by any combination of the two or in any other manner. Furthermore, embodiments according to the disclosure are also directed at methods for operating the described apparatus. The methods for operating the described apparatus include method aspects for carrying out every function of the apparatus.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic view of a privacy application device according to embodiments described herein;

FIGS. 2, 2-1 to 2-3, 3 to 9, 10, and 10-1 to 10-3 show schematic sectional views of a shutter device of a privacy application device according to various embodiments described herein;

FIG. 11 shows a schematic view of a controller for a privacy application device according to embodiments described herein;

FIG. 12 shows a schematic sectional view of a shutter device of a privacy application device according to further embodiments described herein;

FIG. 13 shows a schematic view of a system including an electronic device including a camera, and a privacy application device according to embodiments described herein.

FIG. 14 shows a flow chart of a method for operating a privacy application device according to embodiments described herein;

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

With the increasing use of electronic devices in daily life, interest in the protection of electronic devices from unauthorized access has gained relevance in recent years. Particularly today, it is desirable that data captured by cameras contained in electronic devices such as mobile telephones, laptop computers, and tablets is protected from unauthorized access. The present disclosure uses an electro- or magnetophoretic medium which is enclosed in an uninterrupted volume defined by at least a seal, a front substrate, and a rear substrate to allow or restrict the capture of images by cameras in an electronic device.

Before various embodiments of the present disclosure are described in more detail, some aspects with respect to some terms and expressions used herein are explained.

In the present disclosure, “aperture in a shutter device” may be understood as an area of a shutter device through which a camera can receive light and capture an image. Hereinafter, the term “transparent state” may be understood as a state in which at least a section of a shutter device 200, in particular adjacent to the aperture 260, is unobstructed. Further, the term “transparent state” may be understood as a state in which sufficient light transmission occurs through at least a section of a shutter device 200, which is typically called section B in the figures, adjacent to the aperture 260 of a shutter device 200 so as to receive sufficient light to capture an image. When in a “transparent state”, at least a section, called section B in the figures, of a shutter device 200 may have a total transmission of, for example, 70% to 100%, typically 80% to 100%, and more typically 90% to 100%. When in a “transparent state”, at least a section of a shutter device 200 may have a “transmission haze” of less than about 40%, typically less that about 30%, and more typically less than about 20%.

The term “section of a shutter device” is to be understood as a portion of an uninterrupted volume defined by at least a seal, a front substrate, and a rear substrate. Further, the term “a section of a shutter device adjacent to the aperture 260” is to be understood as a section of a shutter device that is aligned with the aperture 260 in a shutter device 200, as it is exemplarily illustrated in the figures. A front substrate and/or other generally transparent layers may be positioned between the aperture 260 and the section of the shutter device adjacent to the aperture 260, that is, the term “adjacent” as used herein in this context does not necessarily require that the section and the aperture are next neighbors.

The term “total transmission” (T) is to be understood as the amount of incident light that passes through a material. The term “total reflection” relates to the amount of incident light that is reflected from a material. The term “total absorption” relates to the amount of incident light that is absorbed by a material (such that incident light=total transmission+total reflection+total absorption). Moreover, the term “specular transmission” (Tₛ) represents the amount of incident light that passes through a material without being scattered and continues on in the same direction as the incident light direction. The “transmission haze” is to be understood as equal to one hundred times the quantity of the “total transmission” minus the “specular transmission” divided by the “total transmission” amount, 100(T−Tₛ)/T.

The term “non-transparent state” is to be understood as a state in which at least a section of a shutter device 200, typically adjacent to the aperture 260 in a shutter device 200 and which is typically called section B in the figures, is obstructed in order to render an image indistinguishable. Further, the term “non-transparent state” is to be understood as a state in which sufficient light is blocked, scattered or refracted in at least a section of a shutter device 200, typically adjacent to the aperture 260 in a shutter device 200 and which is typically called section B in the figures. When in a “non-transparent state”, at least a section of a shutter device 200, typically adjacent to the aperture 260 in a shutter device 200, may have a total transmission of, for example, below 40%, typically below 30%, and more typically below 20%. When in a “non-transparent state”, a color including one of all perceivable colors in the three dimensions L (lightness), a, and b according to the mathematical model Lab color space through at least a section B of a shutter device 200 correlating to the aperture 260 in a shutter device 200 can be observed. For instance, the perceivable colors may be black, white, green, red, blue, or yellow.

In the present disclosure, the term “mobile charged particles” may be understood as particles that may have a charge (positive or negative charge). Further, the term “mobile charged particles” may refer to particles that may have a color including one of all perceivable colors in the three dimensions L (lightness), a, and b according to the mathematical model Lab color space. For instance, the perceivable colors may be one of black, white, green, red, blue, or yellow. In other embodiments, “black” and “white” are not considered colors herein.

Furthermore, the term “mobile charged particles” refer to particles that can change their position and state in an electro- or magnetophoretic medium 102 by an external stimulus. The external stimulus may be an electric field, a magnetic field, a combination thereof, or the like. The state may change between compressed floc state and dispersed state, or vice versa. The term “compressed floc state” may be understood as a state in which mobile charged particles may be clumped together thereby typically forming a group or groups of mobile charged particles. Further, the term “compressed floc state” may refer to a state in which mobile charged particles may be settled close to or on at least one electrode. The term “dispersed state” may be understood as a state in which mobile charged particles may be distributed or spread in an electro- or magnetophoretic medium 102. The term “electrophoretic” relates to the term “electrophoresis”, which may be understood as the motion of dispersed mobile charged particles 230 relative to a transport medium 204 under the influence of a spatially uniform electric field. Similarly, the term “magnetophoretic” relates to the term “magnetophoresis”, which may be understood as the motion of dispersed mobile charged particles 230, which may be of magnetic or magnetizable material, relative to a transport medium 240 under the influence of a magnetic field.

The term “electrode” may be understood as a conductor to which a voltage of positive or negative polarity can be applied. In this regard, the polarity of an electrode can be established or changed by applying or removing a voltage. The term “applying or removing an alternating voltage” as used herein is to be understood as applying or removing a voltage which changes the polarity of an electrode according to a predefined schedule. Herein, a schedule of changing voltage may also be called alternating voltage. Accordingly, the frequency of an alternating voltage as understood herein may be larger than 0.5 Hz, 1 Hz or even 2 Hz so as to allow the mobile charged particles within the medium to follow the change of the corresponding electrical field. Furthermore, the alternating voltage as used herein may include only one change of voltage per electrode per switching process (with the switching process being a change from a transparent state of the privacy application device to an obscured state or vice versa).

The term “spaced-apart electrodes” may be understood as electrodes (for instance, stripes) that may be separated in space by a distance. For instance, the distance may be, for example, at least 3 μm, typically at least 6 μm, and more typically at least 10 μm. Alternatively or additionally, the distance may be, for example, less than 100 μm, typically less than 90 μm, and more typically less than 80 μm. The electrodes as described herein may generally be arranged in an array.

In embodiments, “the electro- or magnetophoretic medium 102” is enclosed in an uninterrupted volume defined by at least a seal, the front substrate and the rear substrate” refers to an electro- or magnetophoretic medium 102 that completely fills the volume defined by at least a seal, a rear substrate and a front substrate of the shutter device 200.

Hereinafter, the term “operatively isolated” may be understood as not being permitted to operate the privacy application device 100 by an external system or device other than by direct physical interaction with a user. “Operating” may include switching the privacy application device 100 between a transparent state and a non-transparent state, and vice-versa, as well as switching the privacy application device 100 to a partially transparent state. “Operative isolation” may include isolation from optical operation, electrical operation or physical operation by an external system or device other than physical interaction with a user. Hence, the privacy application device of the present disclosure may be fully operationally isolated to any control other than a manual control of a user.

FIG. 1 shows a schematic view of a privacy application device 100 according to embodiments described herein.

The privacy application device 100 includes a shutter device 200 and a controller 300. The shutter device 200 may comprise an electro- or magnetophoretic medium 102 and an aperture 260. The aperture 260 of the shutter device 200 may be aligned with at least a part of the electro- or magnetophoretic medium 102 through which a camera can receive light and capture an image. According to some embodiments, which can be combined with other embodiments described herein, the privacy application device 100 may further include a physical user-operable control 106. User-operable control 106 allows for the user to switch the privacy application device 100 from a transparent state to a non-transparent state, and vice-versa.

User-operable control 106 may include any one of a toggle switch, a push button and a capacitive touch sensor. User-operable control 106 may be provided separate to and electrically coupled with controller unit 300. Alternatively, user-operable control 106 may be integrated into controller unit 300.

User-operable control 106 allows for operation of the privacy application device 100 to be operationally isolated from any other electrical system, such that the privacy application device 100 is physically operable by a user.

According to some embodiments, which can be combined with other embodiments described herein, privacy application device 100 may further include status indicator 107. Status indicator 107 serves to indicate the current state of privacy application device 100 to a user. Status indicator 107 may include an electrical indicator, for example a light-emitting diode (LED), and may be integrated into any one of shutter device 200 or controller unit 300.

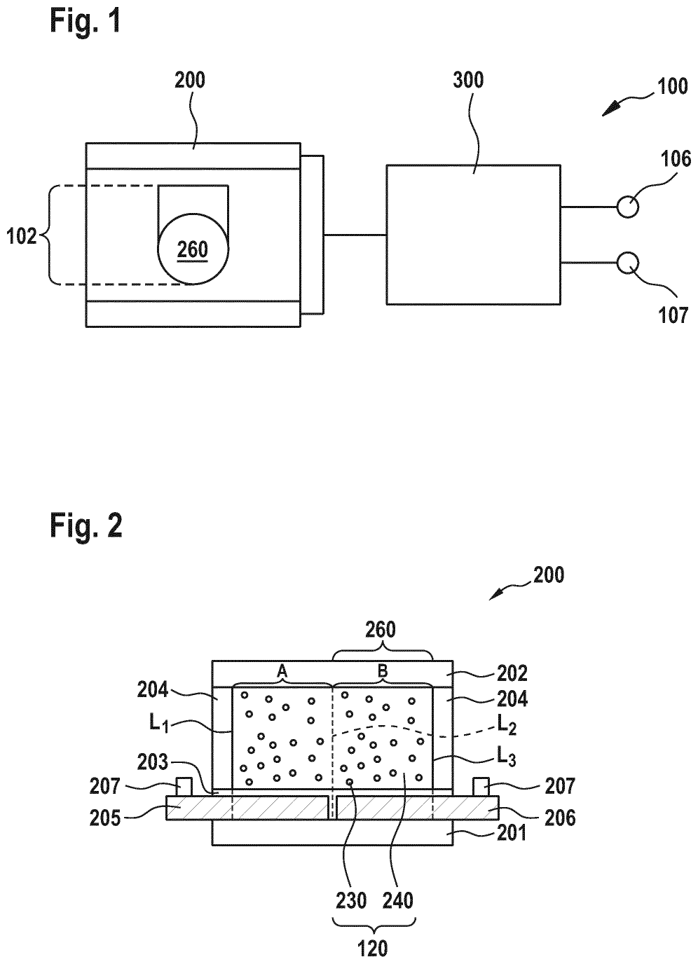

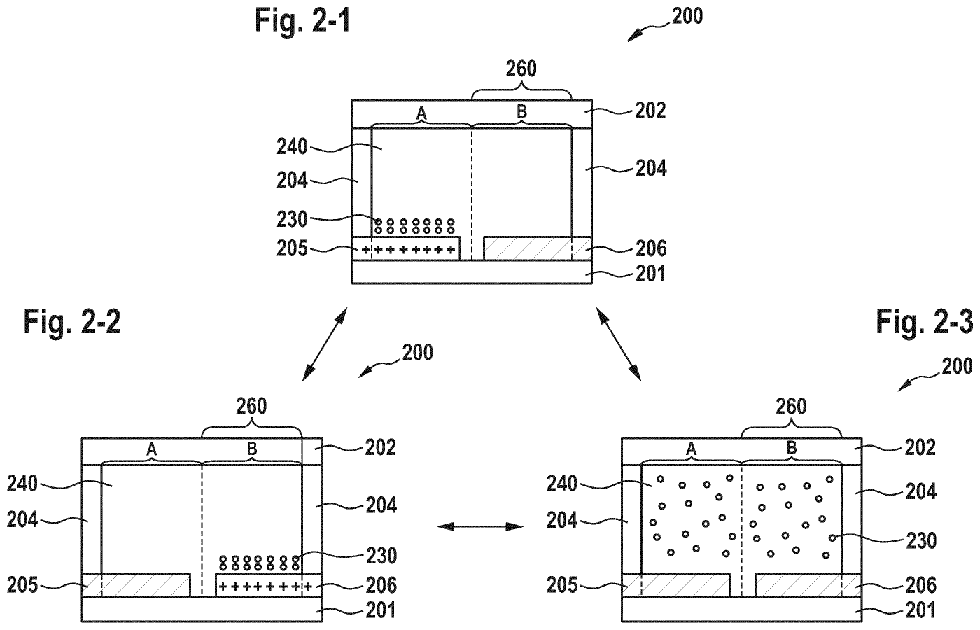

FIGS. 2, 3, and 4 show schematic sectional views of a shutter device 200 according to further embodiments described herein.

Shutter device 200 includes a rear substrate 201 and a front substrate 202. The electro- or magnetophoretic medium 102 may be provided between the rear substrate 201 and the front substrate 202. One or both of the rear substrate 201 and the front substrate 202 may include a ceramic material or a polymer material. For example, the rear substrate 201 and front substrate 202 may include glass. Ceramic materials provide increased stability and good mechanical properties, while polymer materials provide high durability and ease of manufacture. Both ceramic and polymer materials exhibit good optical performance.

Shutter device 200 may further include at least a seal 204. The seal 204 may be provided between the rear substrate 201 and the front substrate 202 such that the seal 204 together with the rear substrate 201 and the front substrate 202 enclose the electro- or magnetophoretic medium 102. The seal typically forms the sides of the shutter device. In embodiments, the electro- and magnetophoretic medium 102 is enclosed in an uninterrupted volume defined by the rear substrate 201, the front substrate 202, and the seal 204. Further, the electro- and magnetophoretic medium 102 may fill the volume defined by the seal, the front substrate, and the rear substrate of the shutter device 200 completely. The seal 204 may be formed to provide a filling opening for introducing electro- or magnetophoretic medium 102 into the uninterrupted volume formed between rear substrate 201, front substrate 202, and seal 204.

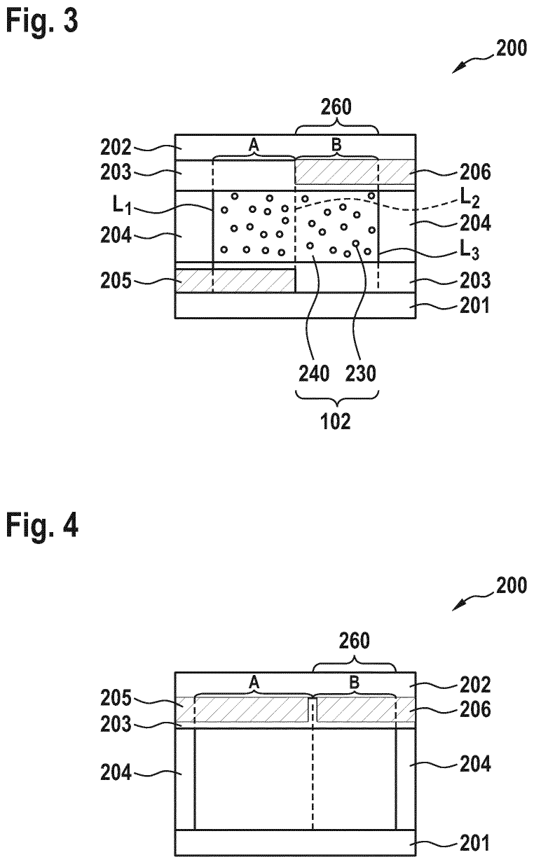

According to some embodiments, which can be combined with other embodiments described herein, shutter device 200 includes at least two electrodes 205, 206 which may be positioned separately on the rear substrate 201 and the front substrate 202 as shown in FIG. 3 or on the same rear substrate 201 or front substrate 202 as shown in FIGS. 2 and 4, respectively. The at least two electrodes 205, 206 cover different areas of the rear substrate 201 and the front substrate 202, respectively.

Electrodes 205 and 206 may be positioned separately in different sections of the shutter device 200, wherein one of the sections may be adjacent to the aperture 260 of the shutter device 200. According to some embodiments, which can be combined with other embodiments described herein, the shutter device 200 may consist of at least two sections, for instance, sections A and B as shown in the figures. For instance, according to FIG. 2, section A may be limited by the front and rear substrates and virtual lines L₁ and L₂, wherein at least part of the line L₁ coincides with a wall of first seal 204. In embodiments, electrode 205 is mostly or completely positioned in the section A of the shutter device 200. Further, section B according to FIG. 2 may be limited by the front and rear substrates and virtual lines L₂ and L₃, wherein at least part of the line L₃ coincides with a border of second seal 204. In embodiments, electrode 206 is mostly or completely positioned in the section B of the shutter device 200, which correlates to the aperture 260 of the shutter device 200. Accordingly, the section B is aligned with the aperture 260 through which a camera can receive light and capture an image.

Although the two sections are shown as being of equal size in the figures, it is also possible that one section is larger. In particular, the section in alignment with the aperture (“section B”) may be larger than the other section (“section A”) which is supposed to gather the mobile charged particles in case the privacy application is in a transparent state.

Electrodes 205, 206 may have different charge at the time by applying a voltage there between. For instance, when electrode 205 is provided with a positive charge, electrode 206 may be provided with a different charge (e.g. negative) by applying the respective voltage. One electrode may also be on a zero potential. In case of the embodiment shown in FIG. 3, the at least two electrodes 205, 206 may vertically overlap in the section A of the shutter device 200. However, only one of the at least two electrodes 205, 206 may be positioned in section B of the shutter device 200, which is aligned with the aperture 260 of the shutter device 200.

In some embodiments, which can be combined with other embodiments described herein, the shutter device 200 may further contain an insulating layer 203 for covering and protecting one or more of the at least two electrodes 205, 206. The material for the insulating layer 203 may include, for example, acrylic resins, polyimide resins, and amorphous fluoro resins can be used. An insulating layer 203 covering and protecting at least one of the electrodes may be present in any embodiment. For the sake of simplicity, hereafter the insulating layer is not shown in further embodiments. However, an insulating layer may be provided in all embodiments as described herein.

Alternatively, and not limited to this embodiment either, the at least two electrodes may be in direct contact with the electro- or magnetophoretic medium.

Electrodes 205, 206 may be formed from a transparent conductive material, for example, indium-tin oxide (ITO). Electrodes 205, 206 may be deposited by a physical vapor deposition process, typically a sputter deposition process.

Shutter device 200 may further include electrode pads. Electrode pads 207 as shown in FIG. 2 allow for the attachment of an electrical connection between the shutter device 200 and a controller unit 300. Electrode pads 207 may be included in at least one of electrodes 205, 206. Alternatively, electrode pads 207 may include a layer deposited upon at least one of electrodes 205, 206, and may include a conductive material such as a ceramic (indium-tin oxide) or a metal (tin, copper, silver, gold, or alloys thereof).

The electro- or magnetophoretic medium 102 may include a mixture of mobile charged particles 230 and a transport medium 240. The mobile charged particles 230 may be particles that are colored or show a color in a dispersed state or compressed floc state. Accordingly, the color may be black, white, green, red, blue, yellow, or a combination thereof. In other embodiments, in particular black is not considered as a color. The mobile charged particles can be used for an electro- and/or magnetophoretic method.

In the present disclosure, electrophoresis is the motion of dispersed mobile charged particles 230 relative to a transport medium 204 under the influence of a spatially uniform electric field. Similarly, magnetophoresis is the motion of dispersed mobile charged particles 230, which may be of magnetic or magnetizable material, relative to a transport medium 240 under the influence of a magnetic field.

The mobile charged particles 230 may include an inorganic material or a polymeric material. The mobile charged particles 230 including an inorganic material can be metal oxide particles (for instance, titanium dioxide) or metal colloidal particles.

Regarding color and stability, metal colloidal particles having the color strength due to the surface plasmon resonance are typically used as mobile charged particles 230. Hereinafter, examples of the metal colloidal particles will be described.

Examples of metals of the metal colloidal particles include noble metals and copper (hereinafter, all together, referred to as metal). Examples of the noble metals may be gold, silver, ruthenium, rhodium, palladium, osmium, iridium, and platinum. Among them, gold, silver, and platinum are typically used.

Methods for obtaining the metal colloidal particles are for instance a chemical method of reducing metal ions and then preparing nano-particles via metal atoms and metal clusters, and a physical method of trapping metals in the form of particles generated by evaporation of a bulk metal in an inert gas using a cold trap, or a physical method of forming a metal thin film on a polymer thin film by vacuum evaporation, then breaking the metal thin film by heating, and successively dispersing the metal particles in a polymer in a solid-phase state.

The metal colloidal particles may be formed from a compound of one or more of the above-mentioned metals. The compound of the metal may be chloroauric acid, silver nitrate, silver acetate, silver perchlorate, chloroplatinic acid, potassium chloroplatinate, cupric chloride, cupric acetate, or cupric sulfate.

The metal colloidal particles can be obtained in the form of a dispersion of metal colloidal particles protected with a dispersant in a transport medium 240 by reducing the above-mentioned metal compounds dissolved in a transport medium 240 to metals. The metal colloidal particles may also be obtained in the form of a solid sol by further removing a solvent of a dispersion liquid. At the time of dissolving the metal compounds in a transport medium 240, a high molecular weight pigment dispersant may be used. Use of the high molecular weight pigment dispersant makes it possible to obtain stable metal colloidal particles protected by the dispersant.

When using metal colloidal particles, the above-mentioned metal colloidal particles having the form of a dispersion in a transport medium 240 or that obtained by re-dispersing the above-mentioned metal colloidal particles having the form of a solid sol in a transport medium 240 can be used.

When using the metal colloidal particles having the form of a dispersion in a transport medium 240, as the transport medium 240 to be used in the preparation, non-polymeric organic materials described below may be used. Further, when using the solid sol for being re-dispersed, as the solvent to be used for preparing the solid sol, any solvent can be used. As the transport medium 240 to be used in the re-dispersion, non-polymeric organic materials described below are typically used.

The volume average particle diameter of the mobile charged particles 230 is 1 to 300 nm, typically 2 to 50 nm, and more typically 5 to 50 nm.

The metal colloidal particles can be colored in various colors based on the type, shape, and volume average particle diameter of the metal. Therefore, use of the mobile charged particles 230 with controlled type, shape, and volume average particle diameter of the metal makes it possible to give various colors including one of all perceivable colors in the three dimensions L (lightness), a, and b according to the mathematical model Lab color space. For instance, the perceivable colors may be black, white, green, red, blue, or yellow. Further, use of the mobile charged particles 230 with controlled type, shape, and volume-average particle diameter of the metal makes at least part of an electro- and magnetophoretic medium 102 through which a camera can receive light and capture an image to be colored in a non-transparent state. Furthermore, control of the shape and particle diameter of the metal and the metal colloidal particles to be obtained makes it possible to give a colored-type privacy application device 100. In particular applications, the color of the mobile charged particles may be aligned with the color of the cover of the electronic device in front of which the privacy application device is positioned.

The content (% by mass) of the mobile charged particles 230 in the total mass of the electro- or magnetophoretic medium 102 is such that a color, in particular a blackening, can be observed in a non-transparent state of the shutter device. It is effective for the privacy application device 100 to adjust the content of the mobile charged particles 230 in accordance with the separation between the front and the rear substrates. Generally, the content (% by mass) of the mobile charged particles 230 in the total mass of the electro- or magnetophoretic medium 102 is at least 0.0001% by mass, typically at least 0.001% by mass, and more typically at least 0.01% by mass. Further, the content (% by mass) of the mobile charged particles 230 in the total mass of the electro- or magnetophoretic medium 102 is up to 70% by mass, typically up to 60% by mass, and more typically up to 50% by mass.

The above-mentioned metal colloidal particles may be prepared by common preparation methods described, for example, in “Synthesis and Preparation of Metal Nano-Particles, Control Techniques and Application Developments”, Technical Information Institute Co., Ltd., 2004.

The mobile charge particles 230 can have a surface treatment. The surface treatment should provide enough steric hindrance to prevent permanent aggregation when the particles may be in the compressed floc state either in the transparent state when driven to an electrode or electrodes mostly positioned in the section A of the shutter device 200 or in the non-transparent state when driven to an electrode or electrodes mostly positioned in the section B of the shutter device 200 correlating to the aperture 260 of the shutter device 200 or when staying dispersed in a transport medium 240. The molecule size of the surface treatment influences the physical properties of the mobile charge particles 230. For instance, the viscosity and aggregation of the mobile charge particles 230 may be influenced by the molecule size of the surface treatment.

The transport medium 240 may include a non-polymeric organic material or a polymeric material. As a transport medium 240 of the above-mentioned metal oxide or metal colloidal particles, non-polymeric organic materials may be used.

Practically, typical examples of the non-polymeric organic material may be hexane, cyclohexane, toluene, xylene, decane, hexadecane, kerosene, paraffin, isoparaffin, silicone oil, dichloroethylene, trichloroethylene, perchloroethylene, high-purity petroleum, ethylene glycol, alcohols, ethers, esters, dimethylformamide, dimethylacetamide, dimethyl sulfoxide, N-methylpyrrolidone, 2-pyrrolidone, N-methylformamide, acetonitrile, tetrahydrofuran, propylene carbonate, ethylene carbonate, benzine, diisopropylnaphthalene, olive oil, isopropanol, trichlorotrifluoroethane, tetrachloroethane, dibromotetrafluoroethane, and their mixtures.

The non-polymeric organic material may be mixed with an acid, an alkali, a salt, a dispersion stabilizer, a stabilizer for oxidation prevention and UV absorption, an anti-bacterial agent, and a preserver. These additives may be added in proper ranges so as to adjust the volume resistance in the above-specified range.

The above-mentioned mobile charged particles 230 (metal oxide or metal colloidal particles) may also be dispersed in a polymeric material. As the polymeric material, polymer gel and network polymer may be used.

Examples of the polymeric material may include polymer gel derived from natural polymers such as agarose, agaropectin, amylose, sodium alginate, alginic acid propylene glycol ester, isolychnane, insulin, ethylcellulose, ethylhydoxyethylcellulose, cardrun, casein, carrageenan, carboxymethyl cellulose, carboxymethyl starch, callose, agar, chitin, and chitosan. Further examples of the polymeric material may include silk fibroin, guar gum, pyrus cydonia seed, crown gall polysaccharide, glycogen, glucomannan, keratan sulfate, keratin protein, collagen, cellulose acetate, gelan gum, schizophyllan, gelatin, vegetable ivory mannan, tunicine, dextran, dermatan sulfate, starch, and gum tragacanth. Moreover, examples of the polymeric material may also include nigeran, hyaluronic acid, hydroxyethyl cellulose, hydroxypropyl cellulose, pustulan, funoran, decomposed hydroxyglucan, pectin, porphyran, methyl cellulose, methyl starch, laminarane, lichenan, lentinan, and locust been gum, and may also include almost all kinds of polymer gel in the case of synthetic polymers.

Further, examples may include polymers containing functional groups such as alcohol, ketone, ether, ester, and amido in repeating unit. For example, polyvinyl alcohol, poly(meth)acrylamide and the corresponding derivatives, polyvinylpyrrolidone, polyethylene oxide and copolymers containing these polymers are also exemplified.

Among them, regarding production stability and electrophoresis property, gelatin, polyvinyl alcohol, and poly(meth)acrylamide are typically used.

These polymeric materials may be typically used in combination with the above-mentioned non-polymeric materials.

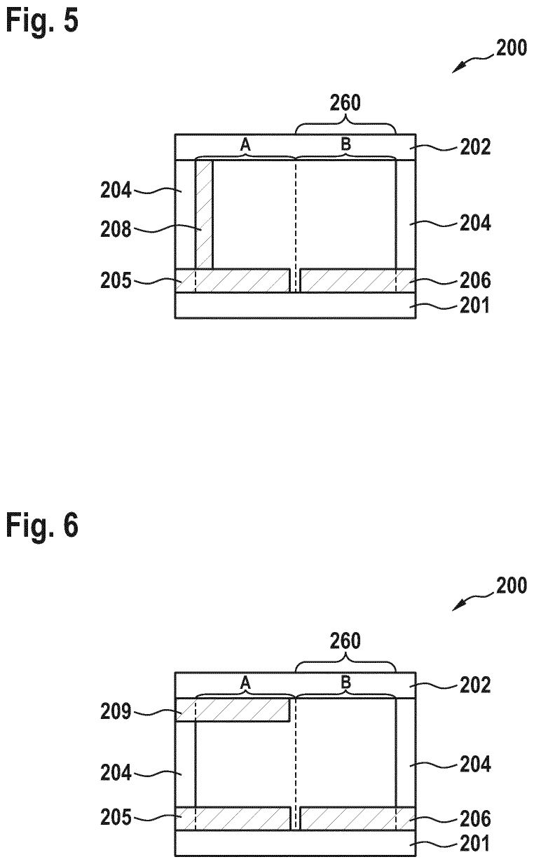

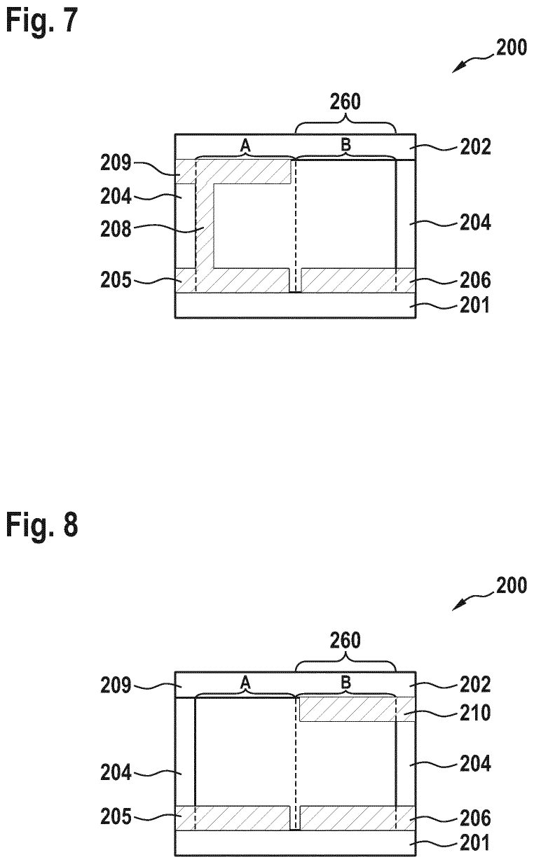

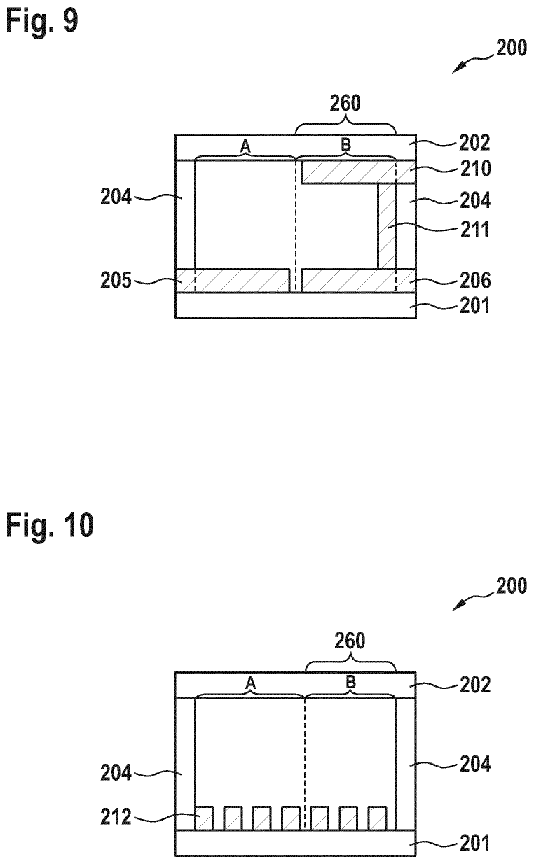

FIGS. 5 to 9 show schematic sectional views of a shutter device 200 according to other aspects of the present disclosure.

Accordingly, shutter device 200 may include further electrodes 208, 209, 210 and/or 211 on the rear substrate 201, the front substrate 202, and/or the seal 204 as shown in FIGS. 5 to 9. Electrodes 205, 206, 208, 209, 210, and/or 211 may be positioned separately in different sections of the shutter device 200, wherein one of the sections is aligned with the aperture 260 of the shutter device 200. For instance, electrodes 205, 208, and/or 209 may be mostly positioned in the section A of the shutter device 200. Electrodes 205, 208, and/or 209 may be interconnected and/or have the same charge at the same interval of time and during the same duration by applying an alternating voltage. Similarly, electrodes 206, 210, and/or 211 may be mostly positioned in the section B of the shutter device 200, which is aligned with the aperture 260 of shutter device 200. Electrodes 206, 210, and/or 211 may be interconnected and/or have the same charge at the same interval of time and during the same duration by applying an alternating voltage. Each of the groups of electrodes 205, 208, and/or 209 and electrodes 206, 210, and/or 211 may have different charges at the same interval of time by applying an alternating voltage. For instance, when electrodes 205, 208, and/or 209 are provided with a positive voltage, electrodes 206, 210, and/or 211 may be provided with different voltage (e.g. negative) or may be neutral.

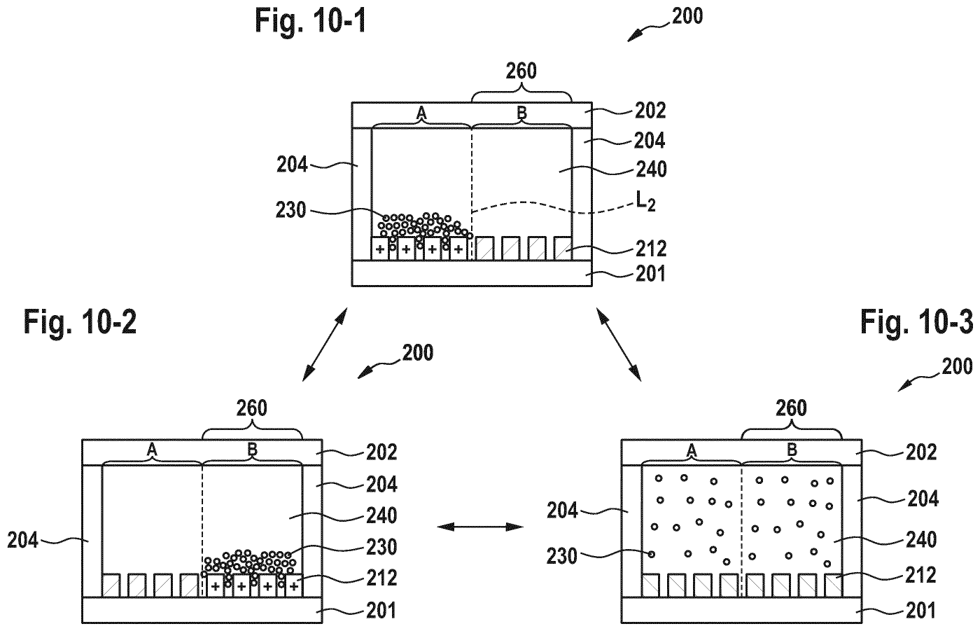

FIG. 10 shows a schematic sectional view of a shutter device 200 according to another aspect of the present disclosure. Generally, and only illustrated in a specific example with overall seven electrodes in FIG. 10, the shutter device as described herein may include 3, 4, or more electrodes.

The at least two electrodes of the present disclosure may also be formed as spaced-apart electrodes on the rear substrate 201, the front substrate 202, and/or the seal 204. The number of spaced-apart electrodes 212 may be, for example, at least 2, typically at least 4, and more typically at least 10. Spaced-apart electrodes 212 may be positioned separately in different sections of the shutter device 200, wherein one of the sections correlates to the aperture 260 of the shutter device 200. For instance, spaced-apart electrodes 212 may be provided on the rear substrate 201 in the sections A and B of the shutter device 200 as shown in FIG. 10. Electrodes 212 may include striped transparent conductive material. Accordingly, electrodes 212 may be provided with different charges, individually or in groups, at the same interval of time by applying an alternating voltage. For instance, the control can be such that, when electrodes 212 positioned in the section A of the shutter device 200 are provided with a positive charge, electrodes 212 positioned in the section B of the shutter device 200, which is in alignment with the aperture 260 of the shutter device 200, may be provided with a different charge, such as a negative or a neutral charge.

By applying an alternating voltage at a specific amplitude and duration and schedule to the multitude of electrodes 205, 206, 208, 209, 210, 211, and/or 212 as explained above, at least a section B of the shutter device 200 correlating to the aperture 260 of the shutter device 200 and, therefore, the privacy application device 100 can be switched between a transparent state and a non-transparent state. Once the switching process is over, in typical embodiments, a constant voltage is applied to the electrodes so as to maintain the state (such as transparent or non-transparent) of the shutter device. Only if switching to a different state, an alternating voltage may be applied again to move the mobile charged particles to different locations again.

FIGS. 2-1, 2-2 and 2-3 show schematic sectional views of a shutter device 200 according to another aspect of the present disclosure so as to explain the operation of the shutter device.

The two different optical states (transparent state and non-transparent state) may be generated by positioning mobile charged particles 230 inside and/or outside of a section B of the shutter device 200 by applying a voltage schedule to the at least two electrodes.

For instance, considering the arrangement of electrodes shown in FIG. 2 presented previously, a transparent state may be generated when alternating voltage is applied to electrode 205 as shown in FIG. 2-1. Accordingly, the electrode 205 may be provided with a positive charge and the mobile charged particles 230 provided with a negative charge may be moved to the electrode 205. In this way, the mobile charged particles 230 may stay close to or on electrode 205 in a compressed floc state as long as the electrode 205 is provided with a positive charge by applying an alternating voltage, so that at least the section B of the shutter device 200, which correlates to aperture 260 of the shutter device 200, is unobstructed in order to distinguish an image. Further, sufficient light transmission occurs through at least the section B of the shutter device 200 correlating to the aperture 260 of the shutter device 200 such as to receive sufficient light to capture an image.

On the other hand, a non-transparent state may be generated when a different voltage is applied to electrode 206 as shown in FIG. 2-2. Accordingly, the electrode 206 may be provided with a positive charge and the mobile charged particles 230 provided with a negative charge may be moved to the electrode 206. In this way, the mobile charged particles 230 may stay close to or on electrode 206 in a compressed floc state as long as the electrode 206 is provided with a positive charge by applying an alternating voltage, so that at least the section B of the shutter device 200, which correlates to aperture 260 of the shutter device 200, is obstructed in order to render an image indistinguishable. Further, sufficient light is blocked, scattered and/or refracted in at least the section B of the shutter device 200, which is in alignment with aperture 260 of the shutter device 200 through which a camera can receive light and capture an image. Furthermore, a color through at least the section B of the shutter device 200 may be observed. Alternatively, while applying a voltage to electrode 205 to generate an electrode 205 provided with a positive charge, a negative voltage can be applied to electrode 206.

A non-transparent state may also be generated when no voltage is applied to electrodes 205 and 206, as illustrated in FIG. 2-3. Accordingly, the mobile charged particles 230 may be distributed in a dispersed state in the transport medium 240 in the shutter device 200. Yet, according to embodiments, even when no voltage is applied to the electrodes 205 and 206, sufficient light may be blocked, scattered and/or refracted in the shutter device 200 so that a camera positioned behind cannot receive sufficient light and information in order to capture a distinguishable image.

FIGS. 10-1, 10-2 and 10-3 show a schematic view of a shutter device 200 according to another aspect of the present disclosure.

Considering the arrangement of electrodes shown in FIG. 10 presented previously, a transparent state may be generated when a voltage is applied to the group of spaced-apart electrodes 212 positioned in the section A of the shutter device 200 as shown in FIG. 10-1. Accordingly, the group of spaced-apart electrodes 212 positioned in the section A of the shutter device 200 may be provided with a positive charge. Therefore, the mobile charged particles 230 provided with a negative charge may be moved to the group of electrodes 212 positioned in the section A of the shutter device 200. In this way, the mobile charged particles 230 may stay close to or on the group of electrodes 212 positioned in the section. Accordingly, at least the section B of the shutter device 200 is unobstructed in order to allow sufficient light transmission to occur through at least the section B of the shutter device 200 so as to receive light and capture an image.

On the other hand, a non-transparent state may be generated when a voltage is applied to the group of electrodes 212 positioned in the section B of the shutter device 200 as shown in FIG. 10-2. Accordingly, the group of electrodes 212 positioned in the section B of the shutter device 200 may be provided with a positive charge. Therefore, the mobile charged particles 230 provided with a negative charge may be moved to the group of spaced-apart electrodes 212 positioned in the section B. In this way, the mobile charged particles 230 may stay close to or on the group of spaced-apart electrodes 212 positioned in the section B of the shutter device 200 distributed in a compressed floc state as long as the voltage is applied to the group of electrodes 212 positioned in the section B. Accordingly, at least the section B of the shutter device 200 in alignment with the aperture 260 of the shutter device 200 is obstructed.

Alternatively, while applying a positive voltage to the group of electrodes 212 positioned in the section A of the shutter device 200, a negative voltage can be applied to the group of electrodes 212 positioned in the section B and vice versa.

Accordingly, switching the privacy application device 100 from a transparent state to a non-transparent state and vice versa may also be conducted stepwise, when a voltage is individually applied to the electrodes 212. For instance, considering FIG. 10-1, applying a negative voltage to the electrodes 212 in section A can be conducted starting from the electrode 212 closest to seal 204. Subsequently, the electrode that is second closest to the seal may also be provided with a negative voltage and so on until all electrodes of section A have a negative charge. Simultaneously, applying a positive voltage can be conducted in a similar manner in section B. Consequently, the mobile charged particles 230 may be progressively driven from section A to section B.

A non-transparent state may also be generated when no alternating voltage is applied to the electrodes 212, as shown in FIG. 10-3. Accordingly, the mobile charged particles 230 may be homogenously distributed in the transport medium 240 in all sections A and B of the shutter device 200 and the incident light may be blocked, scattered and/or refracted.

When in a transparent state, according to the present disclosure, the haze level is typically lower than 5%, lower than 2%, or even lower than 1%. Low haze levels (corresponding to high transmission levels) minimize the blurring effect during camera recording. This allows maximization of light incidence and optimization of contrast. Notably, the camera properties of an electrical device such as a tablet, a mobile phone or the like can be the fundamental reason for consumers to decide for a specific device. Low haze values as provided with embodiments of the present disclosure can therefore be of high importance.

Each of the at least two electrodes, the transport medium, the front substrate, and the rear substrate or everything altogether might have a light transmissivity of at least 90%, typically 95%, and more typically 99%. When the privacy application device 100 is in a transparent state, the refractive index of the transport medium 240 and the electrodes is very similar to the refractive index of the glass or polymer substrates. When the privacy application device 100 is in a non-transparent state, light is strongly blocked, scattered and/or refracted in at least the section B of the shutter device 200 through which a camera can receive light and capture an image because of the presence of mobile charged particles 230 in this section B of the shutter device 200. Accordingly, the camera can only receive an undistinguishable image or a homogenous coloring. Any unauthorized spying through the camera of the electronic device can be prevented.

In the electrode arrangements of FIGS. 5 to 9, the electrodes 208, 209, 210, 211 on the seal and/or in both the rear and front substrate in the sections A and/or B of the shutter device 200 may be used to intensify the stability of the compressed floc state of mobile charged particles 230 and the mobility of the mobile charged particles 230 when driven to an electrode or electrodes positioned in the sections A and/or B of the shutter device 200. Accordingly, the mobile charged particles 230 can be distributed in a compressed floc state close to or on all or some electrodes positioned in the sections A and/or B of the shutter device 200 by applying a voltage to generate a charge in the electrodes as explained above.

When switching the privacy application device 100 to a non-transparent state or a transparent state, the amplitude of the applied voltage may be in a range of up to +/−80 V, typically in a range of up to +/−50 V, and more typically in the range of up to +/−30 V. As used herein, a voltage that is said to be below +/−x V is synonymous with the specification that the absolute value of the voltage is below x V. It is particularly beneficial to control the shutter device on the basis of low voltages as typical electrical devices, such as mobile phones, tablets, portable computers or the like only provide low voltage power. In embodiments, the shutter of the present disclosure can be operated without the need to transform the voltage provided by the power source of the electrical device to a higher voltage value such as a voltage converter element.

According to some embodiments, which can be combined with other embodiments described herein, the electro- or magnetophoretic medium 102 may be confined in a space, wherein the separation between the front and the rear substrates may be from about 1 μm to 100 μm, typically from 2 μm to 50 μm, and more typically from 2 μm to 25 μm. If the separation between the front and the rear substrates is less than 1 μm, the scattering effect is reduced and a sufficiently non-transparent state may be difficult to achieve.

According to some embodiments, which can be combined with other embodiments described herein, the aperture 260 of the shutter device 200 may have an area of up to 2000 mm², typically in the range of 4 mm² to 2000 mm², and more typically in the range of 12 mm² to 100 mm². The aperture 260 of the shutter device 200 may be of any shape, typically a circular, oval, rectangular or square shape. Typical widths of the electrodes as used herein may be, for example, at least 3 μm, typically at least 6 μm, and more typically at least 10 μm. Alternatively or additionally, typical widths of the electrodes as used herein may be, for example, less than 100 μm, typically less than 90 μm, and more typically less than 80 μm.

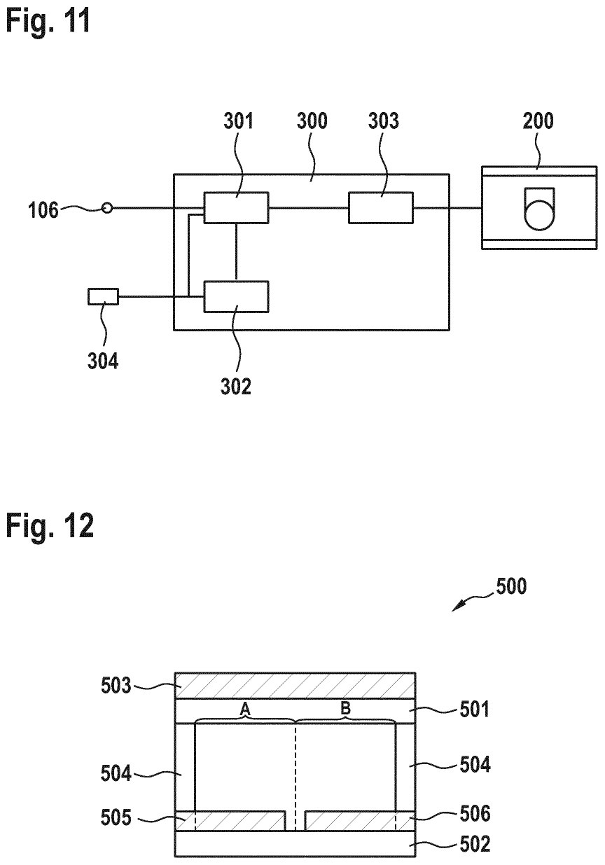

FIG. 11 shows a schematic view of controller unit 300 according to embodiments described herein.

According to some embodiments, which can be combined with other embodiments described herein, controller unit 300 may include a microcontroller unit 301, a voltage converter element 302 and a switching element 303. Controller unit 300 may further include connections to at least one of shutter device 200, user-operable control 106 or power source 304. Alternatively, controller unit 300 may include at least one of shutter device 200 and user-operable control 106.

Microcontroller unit 301 may include a CPU, a memory and input and output device in communication with components included in controller unit 300 and/or with components external to controller unit 300. The input and output device may include at least one of a digital-to-analog converter (DAC), an analog-to-digital converter (ADC), and a pulse width modulator (PWM).

In order for the privacy application device to be switched from a transparent state to a non-transparent state, the applied alternating voltage may be higher than the typical voltages supplied by an electronic device. Voltage converter element 302 includes an electrical circuit for converting input voltage received at power source 304 to an output voltage. For example, voltage converter element 302 may include a step-up converter. The input voltage supplied to voltage converter 302 may be in the range of, for example, 2V to 24V. The output alternating voltage supplied by voltage converter element 302 may be in the range of below +/−80 V. Typically, the voltage may be in the range of below +/−50 V, more typically in the range of below +/−30 V. Voltage converter element 302 may be electrically coupled to microcontroller unit 301, switching element 303 and/or power source 304.

As described previously, in embodiments of the present disclosure the shutter device 200 can be controlled at low voltages. In such a circumstance, it may be possible to omit a voltage converter 302.

In order for the privacy application device to be switched from a transparent state to a non-transparent state, voltage may be applied according to a predefined schedule and pattern. Herein, a predefined schedule and pattern may be called alternating voltage. Switching element 303 includes an electrical switching device for switching the output alternating voltage from voltage converter element 302 for application of alternating voltage to the electrodes of the shutter device 200. Switching element 303 may include at least one of a bipolar junction transistor (BJT) and a field effect transistor (FET). Switching element 303 may be electrically coupled to microcontroller unit 301, voltage converter element 303 and/or shutter device 200. Microcontroller unit 301 may be capable of controlling switching element 303 using, for example, pulse width modulation (PWM) in order to control at least one of the amplitude and duration of the alternating voltage applied to electro- or magnetophoretic medium 102.

According to some embodiments, which may be combined with other embodiments described herein, shutter device 200 may include an electrostatic discharge (ESD) layer. In order to protect shutter device 200 from possible accumulation of static charge, the ESD layer may direct accumulated static charge to an electrode, which may be attached to earth. Earth may be an earth point located on a conductive area of a chassis or frame.

The ESD layer may be deposited on at least a surface of at least one of rear substrate 201 and front substrate 202. The ESD layer may be formed in an etching process where one or more layers of deposited material are etched to form the ESD layer. The ESD layer may be deposited by a physical vapor deposition process, typically a sputter deposition process, and may include a conductive material such as a ceramic (indium-tin oxide) or a metal (tin, copper, silver, gold, or alloys thereof). The ESD layer may be formed to surround the same shape or a similar shape as electro- or magnetophoretic medium 102.

FIG. 12 shows a schematic sectional view of a shutter device 500 according to further embodiments described herein.

According to some embodiments, which can be combined with other embodiments described herein, shutter device 500 further includes at least an anti-reflective layer 503. The addition of anti-reflective layer 503 improves the optical performance of shutter device 500, particularly by improving light transmission. A shutter device 500 including rear/front substrates 501, 502, electrodes 505, 506, and glass and anti-reflective coating 503 can result in a total transmission of 92% or more.

Anti-reflective layer 503 may be provided on at least one of the rear substrate 501 and the front substrate 502. Anti-reflective layer 503 may typically be provided on the outer surface of rear substrate 501. Anti-reflective layer 503 may be deposited by a physical vapor deposition process, typically a sputter deposition process, and may include a ceramic material. For example, anti-reflective layer 503 may include at least one of silicon dioxide, silicon nitride, titanium oxide or niobium oxide. Anti-reflective layer 503 may include one layer of material, or may include two or more layers of material.

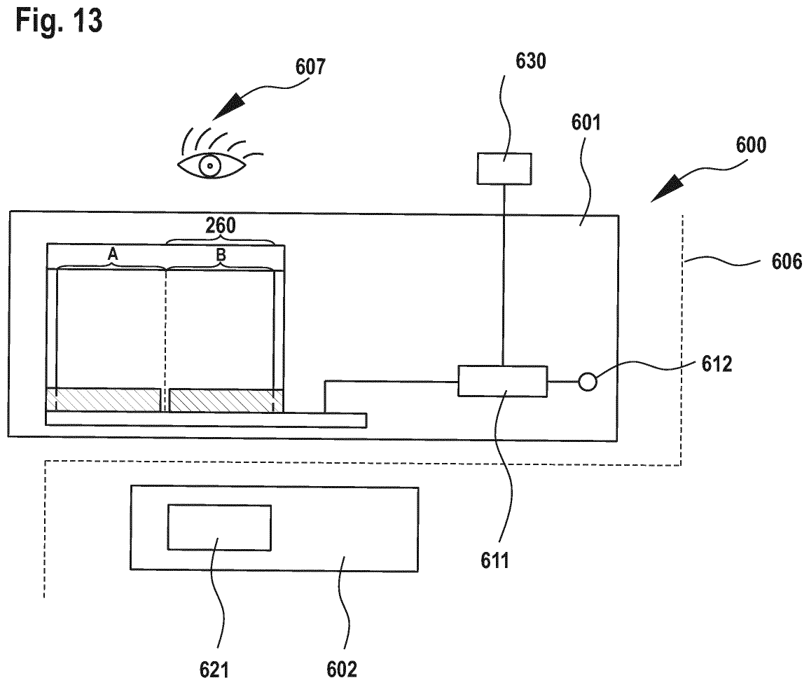

FIG. 13 shows a schematic view of a system 600 including an electronic device 602 including a camera 621 and a privacy application device 601 according to embodiments described herein.

In system 600, privacy application device 601 is provided between a user 607 and a camera 621. Camera 621 may be operatively coupled with electronic device 602. Electronic device 602 may be, for example, a computer, a mobile telephone, a tablet or a game console which records image data from camera 621 for various tasks such as, for example, video telephony, video recording or surveillance. Providing system 600 with privacy application device 601 positioned between user 607 and camera 621 allows the user to block, cover or obscure camera 621 when not in use, in order to improve privacy and security.

According to some embodiments, which may be combined with other embodiments described herein, in system 600, privacy application device 601 may be operatively isolated 606 from electronic device 602.

Due to operative isolation 606 of the privacy application device 601 and electronic device 602, any form of operation of the privacy application device 601 may not be permitted by the electronic device 602. Having privacy application device 601 operationally isolated from electronic device 602 prevents unauthorized control of the privacy application device 601 (such as by a computer virus or the like) and prevents unauthorized recording or viewing of the user, or the environment in which the system 600 is situated, improving privacy and security.

According to some embodiments, which may be combined with other embodiments described herein, privacy application device 601 may be electrically coupled to power source 630. Power source 630 may be a dedicated power source for the privacy application device 601, or may alternatively be a shared power source which supplies power to, for example, privacy application device 601 and electronic device 602.

According to some embodiments, which may be combined with other embodiments described herein, privacy application device 601 may only be physically operable by the user 607. That is, since the privacy application device 601 may be operatively isolated 606 from electronic device 602, the only permissible form of input from a user may be through physical interaction with user-operable control 612, which is connected to a controller unit 611.

According to some embodiments, which may be combined with other embodiments described herein, the components of system 600 including privacy application device 601 and electronic device 602 may be provided in a common housing. Alternatively, privacy application device 601 may be provided in a separate housing to that of a first electronic device 602 such that privacy application device 601 may be removed and installed on a second electronic device 602.

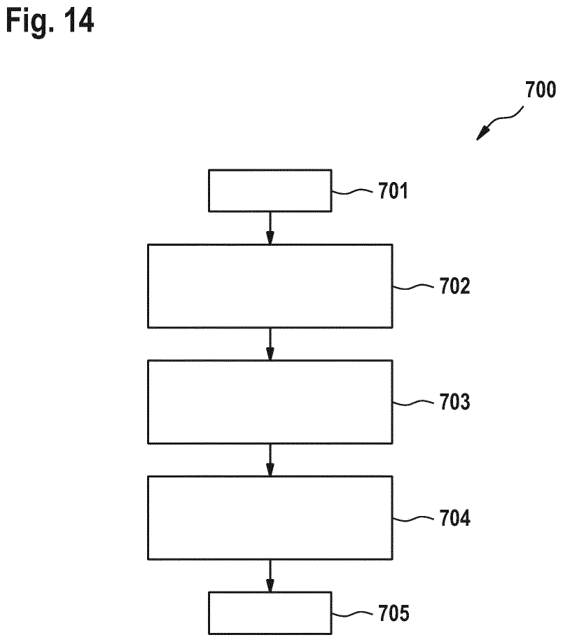

FIG. 14 shows a flowchart of a method 700 for operating a privacy application device according to embodiments described herein. The method 700 can be implemented using the apparatuses and systems according to the present disclosure.

The method 700, beginning at start 701, includes applying an alternating voltage to an electro- or magnetophoretic medium 702, controlling at least one of the amplitude and duration of the applied voltage 703, and keeping and/or removing the applied voltage 704. Method 700 concludes at end 705.

According to some embodiments, which can be combined with other embodiments described herein, controlling the amplitude of the applied voltage 703 when switching the privacy application device 100 to a transparent state or to a non-transparent state may include applying a voltage to selected electrodes as explained above in order to switch the privacy application device 100 to a transparent state or to a non-transparent state.

Removing the alternating voltage 704 causes the privacy application device to remain in a stable non-transparent state. Due to this property of the electro- or magnetophoretic medium 102, the non-transparent state is maintained without the continued application of alternating voltage.

While the foregoing is directed to embodiments of the disclosure, other and further embodiments of the disclosure may be devised without departing from the basic scope thereof, and the scope thereof is determined by the claims that follow.

1. A privacy application device, comprising:
a shutter device including an electro- or magnetophoretic medium, an aperture, and
at least two electrodes; and
a controller unit,
the electro- or magnetophoretic medium including mobile charged particles and a transport medium, wherein the privacy application device is switchable between a transparent state and a non-transparent state.

2. The privacy application device of claim 1, further comprising a front substrate, a rear substrate, and at least a seal, wherein the electro- or magnetophoretic medium is enclosed in an uninterrupted volume defined by the at least one seal, the front substrate, and the rear substrate.

3. The privacy application device of claim 1, wherein each of the at least two electrodes is positioned separately on at least one of the following: the front substrate, the rear substrate, and/or at least a seal.

4. The privacy application device of claim 1, wherein the shutter device comprises at least two sections, wherein one of the sections is positioned adjacent to the aperture of the shutter device.

5. The privacy application device of claim 4, wherein the at least two electrodes are positioned separately in different sections of the shutter device.

6. The privacy application device of claim 2, wherein each of the at least two electrodes, the transport medium, the front substrate, and the rear substrate, typically altogether, have a light transmissivity of at least 90%.

7. The privacy application device of claim 1, wherein the mobile charged particles are colored.

8. The privacy application device of claim 1, wherein one, two or more of the following holds: the front substrate; and the rear substrate comprise one of a ceramic material and a polymeric material; the mobile charged particles comprise one of an inorganic material or polymeric material; the transport medium comprises one of a non-polymeric organic material or a polymeric material; and the at least two electrodes comprise a transparent conductive material.

9. The privacy application device of claim 1, wherein the electro- or magnetophoretic medium is confined in a space, wherein the separation between the front and the rear substrates is from 1 pm to 100 pm.

10. The privacy application device of claim 1, wherein the controller unit comprises:
a microcontroller unit configured for setting up the polarity of the at least two electrodes individually by applying or removing a voltage;
a voltage converter element; and
a switching element,
wherein the switching element is electrically controllable by the microcontroller unit.

11. A method for operating a privacy application device according to claim 1, comprising:
setting up the polarity of the at least two electrodes individually by applying or removing a voltage;
controlling at least one of the amplitude and duration of the voltage to switch the privacy application device between a transparent state and a non-transparent state.

12. The method of claim 11, wherein the amplitude of the voltage is in the range of below +/−80 V.

13. Use of a privacy application device according to claim 1 for a privacy shutter optically positioned in front of at least one camera unit.

14. A system comprising:
an electronic device comprising at least one camera unit; and
a privacy application device according to claim 1,
wherein the privacy application device is positioned in front of at least one camera unit.

15. The system of claim 14, wherein the privacy application device is operationally isolated from the electronic device and is operable only physically by the user.

16. The privacy application device of claim 2, wherein each of the at least two electrodes is positioned separately on at least one of the following: the front substrate, the rear substrate, and at least a seal.

17. The privacy application device of claim 2, wherein the mobile charged particles are colored.

18. The privacy application device of claim 1, wherein the privacy application device is operationally isolated from an electronic device and is operable only physically by the user.

19. The privacy application device of claim 2, wherein the privacy application device is operationally isolated from an electronic device and is operable only physically by the user.

20. The method of claim 11, wherein the privacy application device is operationally isolated from an electronic device and is operable only physically by the user.
